(19) United States
(12) Patent Application Publication
(10) Pub. No.: US 2026/0139810 A1
(43) Pub. Date: May 21, 2026

(54) LIGHTING DEVICE FOR A MOTOR VEHICLE AND MOTOR VEHICLE WITH SUCH A LIGHTING DEVICE

(71) Applicant: HELLA GMBH & CO. KGAA, Lippstadt (DE)

(72) Inventors: Carsten Hohmann, Warstein (DE); Marc Kaup, Paderborn (DE); Martin Mügge, Geseke (DE); Burkhard Peitz, Paderborn (DE)

(21) Appl. No.: 19/388,154

(22) Filed: Nov. 13, 2025

(30) Foreign Application Priority Data
Nov. 15, 2024 (DE) 102024133435.5

(51) Int. Cl. F21S 43/20; F21S 43/14; F21S 43/236; F21S 43/245; F21S 43/249; F21W 103/20; F21W 103/35; F21W 103/55; F21W 107/10; F21Y 113/10; F21Y 115/10

(52) U.S. Cl. CPC F21S 43/2643; F21S 43/14; F21S 43/236; F21S 43/245; F21S 43/249; F21W 2103/20; F21W 2103/35; F21W 2103/55; F21W 2107/10; F21Y 2113/10; F21Y 2115/10

(57) ABSTRACT

A lighting device for a motor vehicle is provided. The lighting device includes a plurality of light sources, at least two light guides, and an at least partially transparent cover. Each of the light guides has an entry surface for the light emitted by at least one of the light sources and an exit surface for the light entering the light guide through the entry surface. The lighting device is configured to be installed in the motor vehicle in such a way that the exit surface of a first of the light guides is arranged on an outer side of a body region of the motor vehicle, so that the light emitted by this first light guide passes directly into the outer space of the motor vehicle, and in that the exit surface of a second of the light guides is arranged behind a body region of the motor vehicle.

### CROSS-REFERENCE TO RELATED APPLICATIONS

The present application claims the benefit of German Patent Application 10-2024-133-435.5, filed Nov. 15, 2024, the disclosures of which is incorporated by reference.

### FIELD OF THE INVENTION

The present invention relates to a lighting device for a motor vehicle and to a motor vehicle with such a lighting device.

### BACKGROUND OF THE INVENTION

A lighting device serving as a tail lamp is known from DE 10 2022 129 705 A1. The lighting device described therein comprises a plurality of light sources, a planar light guide which is larger in the longitudinal direction than in the transverse direction and whose extent in the transverse direction is greater than in the depth direction. The light guide has an entry surface and at least one exit surface. The lighting device further comprises a cover lens, wherein the light generated by the light sources enters the light guide at least partially through the entry surface, the light entering through the entry surface exits at least partially from the at least one exit surface, and the light exiting from the at least one exit surface of the light guide exits the lighting device at least partially through the cover lens. The lighting device further comprises a housing that at least partially surrounds the plurality of light sources, the light guide, and the cover lens. In this case, the thickness of the lighting device is less than 20 mm in the depth direction, perpendicular to the longitudinal direction and the transverse direction, in an area in which light emerges from the cover lens during operation of the lighting device.

Up to now, typical tail lamps have been designed in such a way that they consist of a housing and a cover lens, between which the internal components of the optical systems or design elements are arranged, which form a visible light signature for a tail lamp or a brake light, for example.

This applies in particular to lighting devices which are inserted directly into the body surface and which take over and continue the curvature or the straight line of the body surface as a cover lens. An example of such lighting devices from the prior art is shown in FIG. 11 and FIG. 12. The lighting device shown therein is constructed in two parts, with a first part 1, which is permanently mounted in the rear left-hand corner of the body, and a second part 2, which is mounted adjacent to the first part on the movable tailgate. There is a tailgate gap 3 between the corner of the body and the tailgate, the position of which is indicated in FIG. 11.

FIG. 13 shows a body of a motor vehicle with a distinctively designed transition from a body component 4 forming the corner of the body to the tailgate 5. From the tailgate gap 3, the body surface steps back to form the contour of the tailgate 5 at a lower, rear level. The foremost point of the body is therefore located along the tailgate gap 3. For reasons of installation space and the stability of the tailgate 5, this body profile is difficult to equip with a lighting device that follows the profile because, for example, reinforcements have to be provided at the edge of the tailgate 5, which provides little or no installation space for a lighting device.

### SUMMARY OF THE INVENTION

The problem underlying the present invention is to create a lighting device of the type mentioned at the outset, which can generate a light signature that is recognizable to an observer and extends substantially without major interruptions, even when the body contour is provided with an offset and/or a joint and/or a reinforcement. Furthermore, a motor vehicle equipped with such a lighting device is to be created.

According to the invention, this is achieved by a lighting device of the type mentioned at the outset with the features discussed herein and by a motor vehicle as discussed herein. Other embodiments of the invention are discussed herein.

The lighting device comprises: a plurality of light sources; At least two light guides, each of the light guides having an entry surface for the light emitted by at least one of the light sources and an exit surface for the light entering the light guide through the entry surface; and an at least partially transparent cover, through which the light emitted by at least one of the light guides can pass, wherein the lighting device is designed to be installed in the motor vehicle in such a way that the exit surface of a first of the light guides is arranged on an outer side of a body region of the motor vehicle, so that the light emitted by this first light guide passes directly into the outer space of the motor vehicle, and in that the exit surface of a second of the light guides is arranged behind a body region of the motor vehicle provided with the cover, so that the light emitted by this second light guide only passes into the outer space of the motor vehicle after passing through the cover.

By combining a light guide on the outer side of a body region with a light guide arranged behind a body region provided with the cover, a light signature that is recognizable to an observer and extends substantially without major interruptions can also be created on a body with a distinctively designed contour. In this case, the lighting device can be designed to be installed in the motor vehicle in such a way that the exit surface of the second light guide is offset in the longitudinal direction of the motor vehicle relative to parts of the exit surface of the first light guide and/or relative to the cover. The resulting depth gradient of the various exit surfaces of the light guides can still be perceived by the observer as a light signature extending without major interruptions due to the at least partially transparent cover. At the same time, the depth of the light guides means that their arrangement can be adapted to the body contour and the associated installation space requirements.

It is possible that the exit surfaces of the light guides are elongated and have a longitudinal direction, whereby the exit surfaces of the light guides are more extended in the longitudinal direction, in particular significantly more extended, than in a transverse direction perpendicular to the longitudinal direction. In this case, the longitudinal direction of the exit surface of the first light guide can be at least partially parallel to the longitudinal direction of the exit surface of the second light guide, in particular with the exit surfaces of the two light guides being at least partially aligned with each other, preferably adjoining each other. This reinforces the impression of a light signature that extends without major interruptions.

It may be provided that the lighting device is designed to be installed in the motor vehicle in such a way that the longitudinal direction of the exit surface of at least one of the light guides extends horizontally, in particular with the longitudinal directions of the exit surfaces of several light guides, preferably all light guides, extending horizontally. It may also be provided that the lighting device is designed to be installed in the motor vehicle in such a way that the exit surface of the first light guide is at the same height as the exit surface of the second light guide. This also reinforces the impression of a light signature that extends without major interruptions.

It is possible for the lighting device to be designed to be installed in the motor vehicle in such a way that at least one of the light guides protrudes at least partially outwards from a body region of the motor vehicle. In this case, the light guide can be a so-called edge-lit light guide, in which the exit surface is arranged on the elongated narrow end face of the light guide, which protrudes outwards from the body. This allows a comparatively narrow, elongated light signature to be created. Furthermore, the direct exit of the light from the exit surface into the exterior of the motor vehicle results in a unique design, on the one hand, and saves material for a cover that is not required, on the other hand.

It may be provided that the exit surface of at least one of the light guides is curved at least in sections, in particular wherein the exit surfaces of several light guides, preferably all light guides, are curved at least in sections. The light guides can be suitably adapted to curved body surfaces by bending them accordingly.

It is possible that at least one surface, in particular the entry surface and/or the exit surface, of the at least one light guide is provided with a structure, in particular with a light-deflecting optic, such as a pillow-lens optic or a cylindrical optic, or a prism optic, or with a light-scattering structure, such as an etched structure or an eroding structure, or a laser structure. The structuring can be used to generate suitable light scattering for the desired signaling function, for example, a tail lamp, a brake lamp, or a turn signal lamp. In this case, the structures of the individual light guides can be matched to each other.

It may be provided that the lighting device is set up to allow the light emitted by the light sources to impinge directly on the entry surfaces of the light guides, or to impinge on the entry surfaces of the light guides via a reflector included in the illumination device or to impinge on the entry surfaces of the light guides via a planar light guide included in the lighting device and used for backlighting. All of these variants can ensure suitable illumination of the entry surface of the light guides. The planar light guide that may be used for backlighting can be part of a so-called flat-light module.

It is possible for the light sources to be designed as light-emitting diodes, in particular where the light-emitting diodes are designed as bi-color light-emitting diodes or as multi-chip light-emitting diodes, or where at least one first and at least one second of the light sources differ from one another in terms of the color of the light they generate, in order to implement different signaling functions of the motor vehicle, such as a tail light, a brake light, a turn signal light, or a daytime running light.

In one embodiment the motor vehicle comprises a lighting device according to the invention.

It is possible that the at least partially transparent cover is part of a body component of the motor vehicle.

Furthermore, the body component on which the at least partially transparent cover is arranged may be located in the rear region or in the front region of the vehicle body.

It may be provided that the body of the motor vehicle comprises a tailgate with a tailgate gap bounding the tailgate laterally on the outside, wherein the body component on which the at least partially transparent cover is arranged is adjoining the tailgate gap. In this way, when the lighting device is installed in the vehicle body, an observer sees a light signature that appears to be interrupted in a region adjacent to the tailgate gap, but at the same time continues with an offset in depth. Overall, an observer gets the impression that the light signature continues behind the protruding body, giving the impression of a continuous light signature to the observer.

### BRIEF DESCRIPTION OF THE DRAWINGS

The invention is explained in more detail below with reference to the attached drawings. In the drawings:

FIG. 1 is a perspective view of parts of a lighting device according to the invention with a first, a second, and a third light guide;

FIG. 2 is a perspective view of the lighting device according to FIG. 1, in which the first light guide is not shown;

FIG. 3 is a side view of the lighting device as shown in FIG. 1, in which the second light guide is not shown;

FIG. 4 is a view of the lighting device according to FIG. 1, in which the second light guide is not shown;

FIG. 5 is a detailed perspective view of the lighting device according to FIG. 1, in which the second light guide is not shown;

FIG. 6 is a rear view of a part of the rear region of a motor vehicle according to the invention, with the lighting device as shown in FIG. 1;

FIG. 7 is a perspective view of the rear region of the motor vehicle as shown in FIG. 6 with the lighting device as shown in FIG. 1;

FIG. 8 is a view of the rear region of the motor vehicle corresponding to FIG. 7 as shown in FIG. 6, in which the cover is hidden;

FIG. 9 is a further perspective view of the rear region of the motor vehicle as shown in FIG. 6, in which the cover is hidden;

FIG. 10 is a view of the rear region of the motor vehicle, as shown in FIG. 6, corresponding to FIG. 9, in which the cover is not hidden;

FIG. 11 is a side view of a lighting device according to the prior art;

FIG. 12 is a section according to arrows XII-XII in FIG. 11; and

FIG. 13 is a rear view of a portion of the rear region of a motor vehicle without a lighting device.

### DETAILED DESCRIPTION OF THE CURRENT EMBODIMENTS

In the figures, identical or functionally identical parts are marked with the same reference symbols.

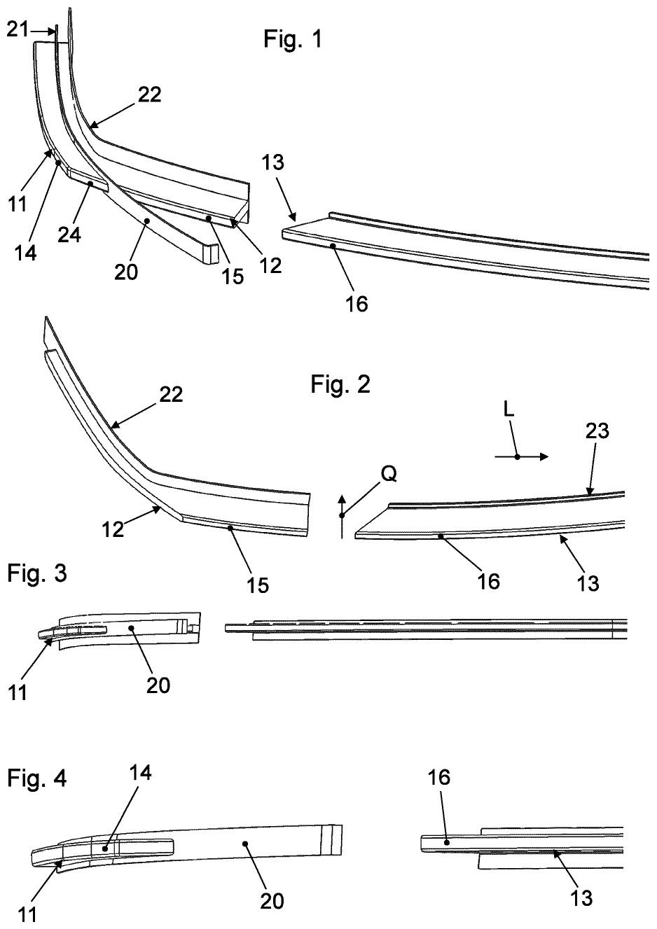

The lighting device shown in FIG. 1 to FIG. 10 comprises a plurality of light sources not shown. The light sources are designed as light-emitting diodes (LEDs), in particular wherein the light-emitting diodes are designed as bi-color light-emitting diodes or as multi-chip light-emitting diodes, or wherein at least a first and at least a second of the light sources are different from one another in terms of the color of the light they generate in order to implement different signaling functions of the motor vehicle, such as a tail light, a brake light, a turn signal light, or a daytime running light.

The lighting device shown in FIG. 1 to FIG. 10 also comprises a first light guide 11, a second light guide 12, and a third light guide 13. It is entirely possible that the lighting device comprises only two light guides 11, 12, 13 or more than three light guides 11, 12, 13.

Each of the light guides 11, 12, 13 has a narrow planar configuration, each of the light guides 11, 12, 13 having an entry surface for the light emitted by at least one of the light sources and an exit surface 14, 15, 16 for the light entering the light guide 11, 12, 13 through the entry surface. At least one surface, in particular the entry surface and/or the exit surface 14, 15, 16 of the light guides 11, 12, 13, is provided with a structuring. The structuring can be a light-deflecting optic, such as a pillow-lens optic or a cylindrical optic, or a prism optic, or a light-scattering structure, such as an etched structure or an eroded structure, or a laser structure.

The lighting device can be set up to allow the light emitted by the light sources to impinge directly on the entry surfaces of the light guides 11, 12, 13 or to impinge on the entry surfaces of the light guides 11, 12, 13 via a reflector (not shown), which is surrounded by the lighting device, or to impinge on the entry surfaces of the light guides 11, 12, 13 via a planar light guide (not shown), which is surrounded by the lighting device and used for backlighting. The planar light guide that may be used for backlighting can be part of a so-called flat-light module.

Each of the light guides 11, 12, 13 is designed as a so-called edge-light light guide, in which the exit surface 14, 15, 16 is arranged on the elongated narrow end face of the light guide 11, 12, 13, which projects outwards from the body when installed. The entry surface can, for example, be arranged on the elongated end face of the light guide 11, 12, 13 opposite the exit surface 14, 15, 16. Alternatively, the entry surface can also be arranged on one of the short end faces of the respective light guide 11, 12, 13.

The exit surfaces 14, 15, 16 of the light guides 11, 12, 13 are elongated and have a longitudinal direction L, each of the exit surfaces 14, 15, 16 of the light guides 11, 12, 13 being significantly more extended in the longitudinal direction L than in a transverse direction Q perpendicular to the longitudinal direction L (see FIG. 2). This allows a comparatively narrow, elongated light signature to be created. The exit surfaces 14, 15, 16 of the light guides 11, 12, 13 are curved in sections.

The longitudinal directions L of the exit surfaces 14, 15, 16 of the light guides 11, 12, 13 are at least in sections parallel to the longitudinal directions of the exit surfaces 14, 15, 16 of the respective other light guides 11, 12, 13. When the lighting device is installed in the motor vehicle, the longitudinal directions of the exit surfaces 14, 15, 16 of the light guides 11, 12, 13 extend horizontally. In this case, the exit surfaces 14, 15, 16 of the light guides 11, 12, 13 are arranged at the same height as the exit surfaces 14, 15, 16 of the other light guides 11, 12, 13.

The first light guide 11 and the second light guide 12 are arranged on a body component 17 of the motor vehicle that forms the corner of the body (see, for example, FIG. 6 and FIG. 9). The tailgate 19 of the motor vehicle is connected to this body component 17 behind a tailgate gap 18. The body surface steps back from the tailgate gap 18 to form the contour of the tailgate 19 at a lower, rear level. The third light guide 13 is arranged on the tailgate 19 (see FIG. 6, for example).

The lighting device also comprises an at least partially transparent cover 20. The lighting device is installed in the motor vehicle in such a way that the first light guide 11 extends outwards from the body component 17, so that the light emitted from the exit surface 14 of the first light guide 11 passes directly into the exterior of the motor vehicle. The second light guide 12 is partially arranged inside the body behind the cover 20, so that the light emitted from the exit surface 15 of the second light guide 12 only reaches the exterior of the motor vehicle after passing through the cover 20 (see FIG. 1).

Due to this design, the exit surface 15 of the second light guide 12 has an offset in the longitudinal direction of the motor vehicle, relative to parts of the exit surface 14 of the first light guide 11 and to the cover 20 (see FIG. 1). Since the cover 20 in front of the exit surface 15 of the second light guide 12 is transparent, the two exit surfaces 14, 15 of the first and second light guides 12 produce a continuous narrow light signature for an observer, even though the exit surface 14 of the first light guide 11 is arranged outside the body and the exit surface 15 of the second light guide 12 is arranged inside the body.

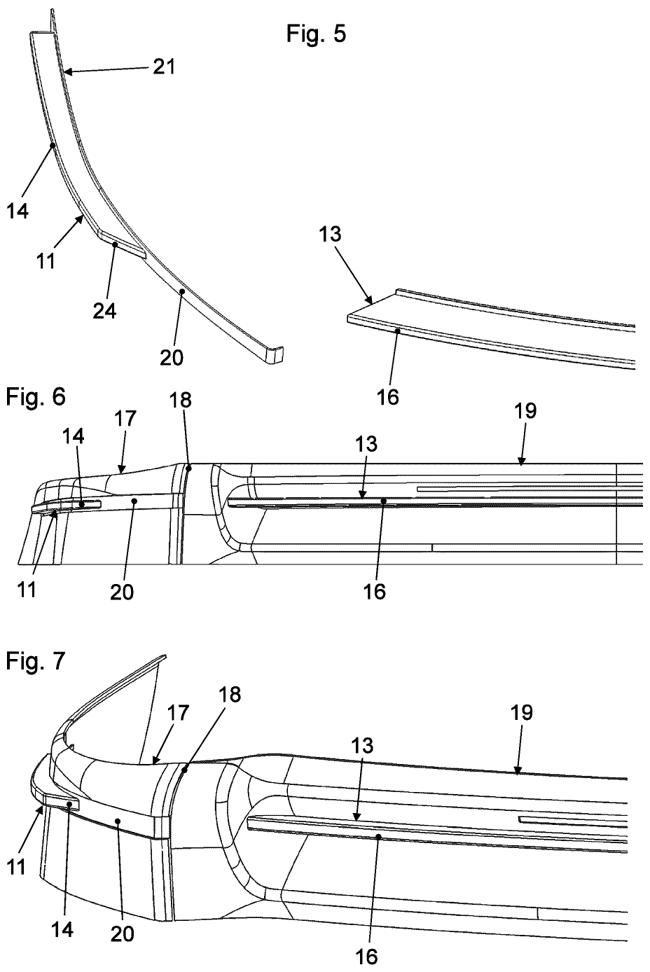

The lighting device can comprise a first elongated, flat, transparent lens panel 21, on the front side of which a light-guide geometry is formed in sections, which forms the first light guide 11 (see FIG. 5). In this case, the entry surface of the light guide 11 for the light emitted by at least one of the light sources can be formed on the first lens panel 21. Light entering the first lens panel 21 through the entry surface can enter the light-guide geometry forming the first light guide 11 and exit the exit surface 14.

The lighting device may further comprise a second elongated, flat, transparent lens panel 22, on the front side of which a light-guide geometry is formed in sections, which forms the second light guide 12 (see FIG. 2). The entry surface of the light guide 12 for the light emitted by at least one of the light sources can be formed on the second lens panel 22. Light entering the second lens panel 22 through the entry surface can enter the light-guide geometry forming the second light guide 12 and exit from the exit surface 15.

The lighting device can further comprise a third elongated, flat, transparent lens panel 23, on the front side of which a light-guide geometry is formed in sections, which forms the third light guide 13 (see FIG. 2). The entry surface of the light guide 13 for the light emitted by at least one of the light sources can be formed on the third lens 23. Light entering the third lens panel 23 through the entry surface can enter the light-guide geometry forming the third light guide 13 and exit from the exit surface 16.

The cover 20 can be designed as part of the first lens panel 21. The first and the second lens panels 21, 22 are arranged at least partially one behind the other in the longitudinal direction of the motor vehicle (see FIG. 1). This enables the simultaneous use of the first lens panel 21 with the light-guide geometry forming the first light guide 11 as a cover 20 for the second light guide 12 formed as a light-guide geometry on the second lens panel 22. The light emitted from the exit surface 15 of the second light guide 12 can pass through the cover 20 of the first lens panel 21.

In this case, the expansion of the light-guide geometry forming the first light guide 11 is reduced in the end region 24 adjacent to the cover 20 until the light-guide geometry retracts into the base surface of the lens panel 21. Subsequently, the light-guide geometry forming the second light guide 12 is similarly continued on the second lens panel 22 behind the cover 20, wherein light emitted by the light-guide geometry of the second lens 22 forming the second light guide 12 passes through the front cover 20.

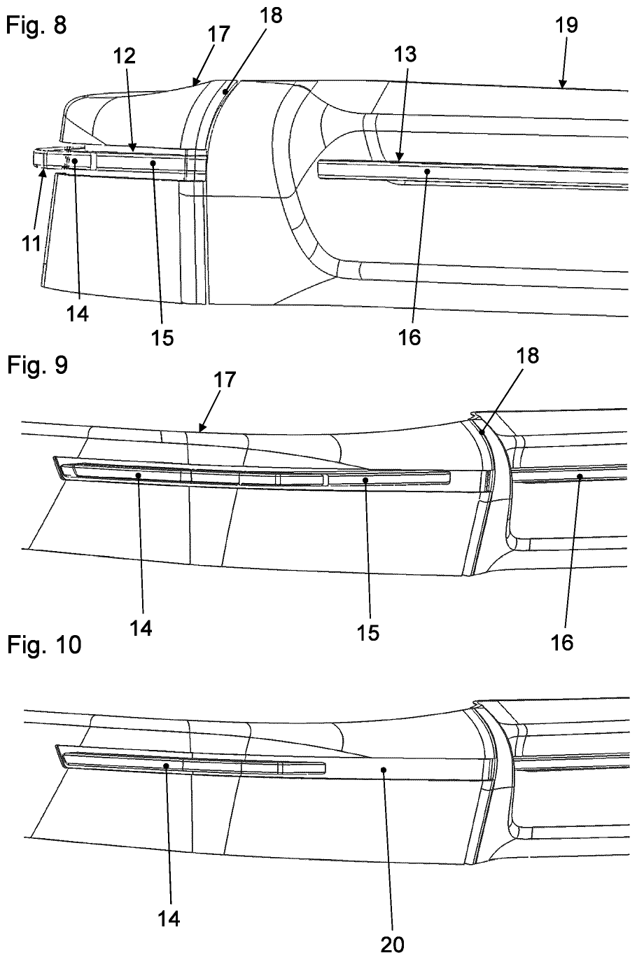

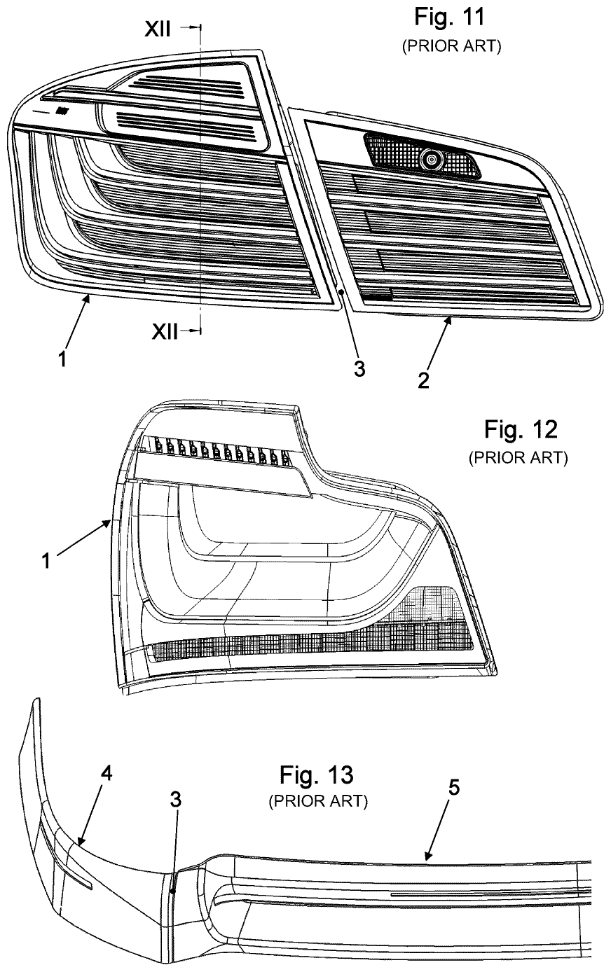

FIG. 6, FIG. 7, and FIG. 10 show the lighting device with the cover 20, so that the exit surface 15 of the second light guide 12 is not visible. FIG. 8 and FIG. 9 show the lighting device with the cover 20 hidden so that the exit surface 15 of the second light guide 12 is visible. It can be seen that, to an observer, the exit surfaces 14, 15 of the first and the second light guides 12 are substantially adjacent to each other.

When the lighting device is installed in the motor vehicle, the third light guide 13 extends outwards from the tailgate 19, so that the light emitted from the exit surface 16 of the third light guide 13 passes directly into the exterior of the motor vehicle (see, for example, FIG. 4).

Alternatively, the partially transparent cover 20 can also be part of the body component 17, forming the body corner.

### LIST OF REFERENCE NUMBERS

1 first part of a lighting device according to the prior art
2 second part of a lighting device according to the prior art
3 taillight gap
4 body component forming a body corner
5 tailgate
11 first light guide
12 second light guide
13 third light guide
14 exit surface of the first light guide
15 exit surface of the second light guide
16 exit surface of the third light guide
17 body component forming a body component
18 tailgate gap
19 tailgate
20 first lens panel
21 second lens panel
22 third lens panel
24 end region of the first light guide
L longitudinal direction of the exit surface
Q transverse direction of the exit surface

The above description is that of a current embodiment of the invention. Various alterations and changes can be made without departing from the spirit and broader aspects of the invention. This disclosure is presented for illustrative purposes and should not be interpreted as an exhaustive description of all embodiments of the invention or to limit the scope of the claims to the specific elements illustrated or described in connection with these embodiments. Any reference to elements in the singular, for example, using the articles “a,” “an,” “the,” or “said,” is not to be construed as limiting the element to the singular.

1. A lighting device for a motor vehicle, comprising:
a plurality of light sources,
at least two light guides, each of the light guides having an entry surface for the light emitted by at least one of the light sources and an exit surface for the light entering the light guide through the entry surface, and
an at least partially transparent cover through which the light emitted by at least one of the light guides can pass, the lighting device being arranged to be installed in the motor vehicle in such a way that the exit surface of a first of the light guides is arranged on an outer side of a body region of the motor vehicle, so that the light emitted by this first light guide passes directly into the outer space of the motor vehicle, and in that the exit surface of a second of the light guides is arranged behind a body region of the motor vehicle provided with the cover, so that the light emitted by this second light guide passes into the outer space of the motor vehicle only after passing through the cover.

2. The lighting device according to claim 1, wherein the lighting device is designed to be installed in the motor vehicle in such a way that the exit surface of the second light guide has an offset in the longitudinal direction of the motor vehicle with respect to parts of the exit surface of the first light guide and the cover.

3. The lighting device according to claim 1, wherein the exit surfaces of the light guides are elongated and have a longitudinal direction, the exit surfaces of the light guides being more extended in the longitudinal direction than in a transverse direction perpendicular to the longitudinal direction.

4. The lighting device according to claim 3, wherein the longitudinal direction of the exit surface of the first light guide is in sections parallel to the longitudinal direction of the exit surface of the second light guide, and wherein the exit surfaces of the two light guides are in sections aligned with one another.

5. The lighting device according to claim 3, wherein the lighting device is arranged to be installed in the motor vehicle in such a way that the longitudinal direction of the exit surface of at least one of the light guides extends horizontally with the longitudinal directions of the exit surfaces of a plurality of light guides.

6. The lighting device according to claim 1, wherein the lighting device is designed to be installed in the motor vehicle in such a way that the exit surface of the first light guide is at the same height as the exit surface of the second light guide.

7. The lighting device according to claim 1, wherein the lighting device is arranged to be installed in the motor vehicle in such a way that at least one of the light guides projects at least partially outwards from a body region of the motor vehicle.

8. The lighting device according to claim 1, wherein the exit surface of at least one of the light guides is curved at least in sections.

9. The lighting device according to claim 1, wherein at least one surface of the at least one light guide is provided with a structuring or a light-scattering structure.

10. The lighting device according to claim 1, wherein the lighting device is set up to cause the light emitted by the light sources to impinge directly on the entry surfaces of the light guides, to impinge on the entry surfaces of the light guides via a reflector surrounded by the lighting device, or to impinge on the entry surfaces of the light guides via a planar light guide surrounded by the lighting device and used for backlighting.

11. The lighting device according to claim 1, wherein the light sources are designed as bi-color light-emitting diodes or as multi-chip light-emitting diodes, and wherein at least a first and at least a second of the light sources differ from one another with regard to the color of the light they generate in order to implement different signaling functions of the motor vehicle.

12. A motor vehicle having a lighting device according to claim 1.

13. The motor vehicle according to claim 12, wherein the at least partially transparent cover is part of a body component of the motor vehicle.

14. The motor vehicle according claim 13, wherein the body component, on which the at least partially transparent cover is arranged, is arranged in the rear region or in the front region of the vehicle body.

15. The motor vehicle according to claim 13, wherein a body of the motor vehicle comprises a tailgate with a tailgate gap laterally externally delimiting the tailgate, and wherein the body component, on which the at least partially transparent cover is arranged, adjoins a tailgate joint.
